(19) United States
(12) Patent Application Publication
(10) Pub. No.: US 2018/0270200 A1
(43) Pub. Date: Sep. 20, 2018

(54) Active Inventory Discovery for Network Security

(71) Applicant: T-Mobile USA, Inc., Bellevue, WA (US)

(72) Inventor: Cameron Byrne, Seattle, WA (US)

(21) Appl. No.: 15/458,331

(22) Filed: Mar. 14, 2017

(51) Int. Cl. H04L 29/06

(52) U.S. Cl. CPC H04L 63/0263; H04L 69/329; H04L 63/0236; H04L 63/20

(57) ABSTRACT

Systems, devices, and techniques described herein are directed to active inventory discovery for network security. For example, a firewall can apply security policies to control network traffic entering and exiting a trusted network. The firewall may maintain an active inventory of network devices as well as policies that apply to the specific devices. A network security device including the firewall may determine devices that are associated with a trusted network, and may enumerate through the devices to discover one or more protocols or ports associated with the devices. Next, various security policies can be applied to the devices in the trusted network to monitor, control, shape, track, or inform at least some aspects of network traffic. The active inventory can be updated by the firewall, to provide comprehensive network security as devices and features change within the trusted network.

### BACKGROUND

Trusted networks of computing devices are often protected by firewalls that monitor and control incoming and outgoing traffic between the trusted network and an external, untrusted network. Prior art systems have deployed firewalls to control network traffic based on a designed topology of a network. However, prior art deployment of firewalls takes immense effort and is further aggravated when it comes to design and topology changes, as examples.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example environment including a security server implementing the active inventory discovery for network security, as described herein.

FIG. 2 illustrates an example environment including a security base station for implementing the network security in a home network, for example.

FIG. 3 illustrates an example security device configured to implement network security.

FIG. 4 illustrates an example process for discovering devices on a network and implementing network security.

FIG. 5 illustrates an example process for resolving network security policies between devices in a network.

FIG. 6 illustrates an example process for applying a security policy to a device based on a device profile.

### DETAILED DESCRIPTION

The systems, devices, and techniques described herein are directed to active inventory discovery for network security. For example, a firewall can apply security policies to control network traffic entering and exiting a trusted network. To provide comprehensive network security, the firewall may maintain an active inventory or catalog of network devices as well as policies that apply to the specific devices. To maintain an active inventory, a network security device may determine devices that are associated with a trusted network, and may enumerate through the devices to discover one or more protocols or ports that are capable of responding. Once the inventory of devices is determined, various security policies can be applied to the devices in the trusted network to monitor, control, shape, track, or inform at least some aspects of network traffic. Thus, a firewall can implement both enforcement and audit functions to provide comprehensive security in a network environment.

Further, the active inventory discovery systems, devices, and techniques can be used herein to resolve differences in network security policies in various geographic locations. For example, a network security device in a first location may provide a first access profile to devices in a trusted network, while a network security device in a second location may provide a second access profile to the devices in the trusted network. By identifying devices on a trusted network, determining capabilities of the devices to generate an active inventory of network devices, security policies can be established at the network security device in the first location and the second location. The security policies can be compared, and any differences in security policies can be identified and resolved. Thus, the systems, devices, and techniques described herein may improve a consistency in security policies from various geographical locations in a network.

Further, the systems, devices, and techniques can be used in a home networking context to provide active inventory discovery for devices connected to the Internet of Things (IoT). For example, a network security device, such as a security base station, can discover devices on a home network and can enumerate through various policies and ports associated with the devices to determine a device profile associated with the device. The security base station can provide the device profile to a network security device, which can determine a type of device based at least in part on the device profile. Based at least in part on the type of device and/or the device profile, the network security device and/or the security base station can establish a policy with respect to the device on the home network to provide targeted access to one or more networks.

For example, a smart appliance, such as a smart refrigerator, may be connected to a home network. A security base station can assign an IP (Internet Protocol) address to the smart appliance, which can trigger the security base station to enumerate through the capabilities of the smart appliance, for example, to determine which protocols and/or ports are configured for operation. The security base station can determine a device profile associated with the smart appliance, and based at least in part on the device profile, can determine an identity of the device and can determine a policy associated with the device. For example, the smart appliance may be permitted to access servers associated with the manufacturer to the device (e.g., to update firmware of the device) or to access a server associated with weather (e.g., to display daily weather on the device), but may be restricted from accessing other servers or the internet in general. As may be understood, the security device can apply any security policy.

The systems, devices, and techniques described herein provide advances over prior art systems that deploy security policies based on a designed network topology. For example, there may be a gap between what was designed and what was deployed as devices in a network, or additional services, protocols, and/or ports may be enabled without updating security policies, in the prior art. Further, prior art system may have relied on self-reporting, which can result in an incomplete view of network devices and/or policies that do not reflect an actual topology of a network.

In this manner, the systems, devices, and techniques described herein improve a functioning of a computing device by improving network security by actively cataloging network devices and applying security policies to the network devices. Further, resolving differences in security policies can improve an experience of the user by providing a consistent experience from various locations. In an IoT context, the systems, devices, and techniques can provide a targeted security policy based on the functions of the device and/or based on a type of device. These and other improvements to the functioning of a computer and network are discussed herein.

The systems, devices, and techniques described herein can be implemented in a number of ways. Example implementations are provided below with reference to the following figures.

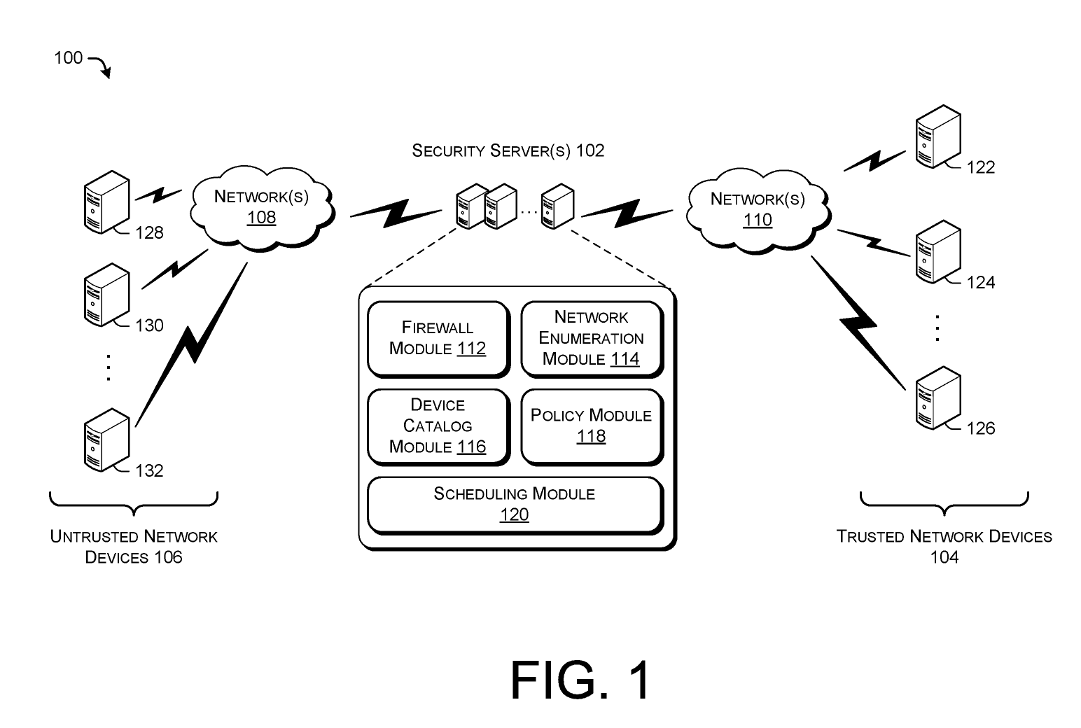

FIG. 1 illustrates an example environment 100 including a security server implementing the active inventory discovery for network security, as described herein. In some instances, the environment 100 can include one or more security server(s) 102 providing services to one or more trusted network devices 104 and one or more untrusted network devices 106 via one or more networks 108 and 110.

Turning to the security server(s) 102 (also referred to as a security server 102), the security server 102 may include various modules including, but not limited to, a firewall module 112, a network enumeration module 114, a device catalog module 116, a policy module 118, and a scheduling module 120. In some instances, the security server 102 may facilitate communication between devices 122, 124, and 126 comprising the trusted network devices 104 and devices 128, 130, and 132 comprising the untrusted network devices 106. In some instances, the network 110 including the devices 122, 124, and 126 may be considered to be a trusted network, and the network 108 including the devices 128, 130, and 132 may be considered to be an untrusted network. Aspects of the various modules of the security server 102 are discussed herein.

The firewall module 112 may include functionality to monitor, control, or otherwise affect the traffic between the trusted network devices 104 and the untrusted network devices 106. In some instances, the firewall module 112 may allow access or deny access to the devices 122, 124, and 126 based on services provided by the devices 122, 124, and 126, protocols supported by the devices 122, 124, and 126, ports used by the devices 122, 124, and 126, etc. In some instances, the firewall module 112 may manage traffic based on the source of the traffic from the untrusted network devices 106 to any of the trusted network devices 104. For example, and without limitation, the device 128 may be allowed to access the devices 122 and 124, but may be blocked by the firewall module 112 from accessing the device 126. Conversely, the firewall module 112 may manage traffic based on the source of traffic from the trusted network devices 104 to any of the untrusted network devices 106. In some instances, the firewall module 112 may be considered a network firewall that filters traffic between two more networks (e.g., the networks 108 and 110).

As noted above, the firewall module 112 may operate to control both outgoing and incoming to the trusted network devices 104. For example, the firewall module 112 may prevent, monitor, limit bandwidth, limit protocols or ports, or otherwise restrict traffic from the trusted network device 104 to the untrusted network devices 106. For example, the device 122 may be able to access the device 128, but may be restricted from accessing the devices 130 and 132.

The firewall module 112 may include any number of packet filters, stateful filters, or application layer filters. That is, in some instances, the firewall module 112 may filter packets based on network addresses and ports of the packet to determine whether that packet should be blocked. Further, in some instances, the stateful filters of the firewall module 112 may analyze packets to determine whether packets are a start of a new connection, part of an existing connection, or not part of any connection. Further, the firewall module 112 may monitor traffic based on an application that is a source or destination of the packets.

The firewall module 112 may include any number of policies or rules which control or otherwise dictate what to do with packets entering or leaving a network. Examples of policies include but are not limited to, bandwidth control, source/destination control, malicious traffic policies, control of ports and/or protocols, etc. Additional details of the firewall module 112 are discussed throughout this disclosure.

The network enumeration module 114 may include functionality to determine devices to be included as the trusted network devices 104 and to probe, test, or otherwise determine functions provided by each of the devices 122, 124, and 126 of the trusted network devices 104. For example, the network enumeration module 114 may determine the trusted network devices 104 based on a routing table or IP table included in the security device 102. Further, the enumeration module 114 may include network mapping functionality such as Nmap to discover hosts and services on the network 110, such as the trusted network devices 104, for example. In some instances, a range of IP (Internet Protocol) address may be searched for functionality, which may be manually selected by a network administrator, for example.

In some instances, the network enumeration module 114 may send probes to devices in the network 110, such as the trusted network devices 104. The network enumeration module 114 may include any number of features, including but not limited to: host discovery, port scanning (e.g., TCP (transmission control protocol) and UDP (user datagram protocol)), version detection, operating system detection, ping sweeps, etc. The network enumeration module 114 can include functionality to identify network connections that can be made from the security device 102 to any or all of the trusted network devices 104. Further, the network enumeration module 114 can include functionality to identify network connections that can be made from one or more of the untrusted network devices 106 to one or more of the trusted network devices 104. The network enumeration module 114 can determine new devices that have been added to the network 110, and can determine open ports, protocols provided by various devices, etc. In some instances, the enumeration module 114 can generate traffic to devices on the network 110 to determine response times, congestion behavior, etc.

Further, the network enumeration module 114 can include functionality to map connections between the trusted network devices 104, for example. In some instances, the network enumeration module 114 can probe the network 114 by sending probes to various devices 122, 124, and 126 to map a physical topology of the network. For example, the network enumeration module 114 can send a probe message or packet to a particular network device causing the network device to append identifying information to the probe message and transmit associated probe messages via physical connections to connected ports to map connections between ports on network devices.

The device catalog module 116 may include functionality to receive a network topology from the network enumeration module 114 to store an active inventory of the trusted network devices 104, as discussed herein. The device catalog module 116 can store device information such as IP address, supported protocols, enabled and disabled ports, etc. that have been discovered by the network enumeration module 114.

The policy module 118 may include functionality to provide one or more security policies to the devices maintained in the device catalog module 116 to provide updated firewall features to the firewall module 112. For instance, the policy module 118 can include packet filtering and policies, stateful filtering and policies, and application layer filtering and policies. The policy module 118 may further include a default or baseline policy to be applied to devices of the network 110. In some instances, the policy module 118 may include policies directed to individual devices or classes of devices on the network 110. The policy module 118 may specify rules for individual users, groups of users, etc.

The scheduling module 120 may include functionality to implement the active inventory discovery for network security, as discussed herein. In some instances, the scheduling module 120 can schedule the network enumeration module 114 to operate on any regular or irregular frequency or interval, such as hourly, daily, weekly, monthly, etc. In some instances, the scheduling module 120 can determine a time where the active inventory discovery begins and/or completes. In some instances, the scheduling module 120 can determine periods of low network activity so as not to add to network traffic during periods of high use. In some instances, the scheduling module 120 may receive an indication (e.g., from a network administrator) to begin the operations disclosed herein. In some instances, the scheduling module 120 may receive an indication that a device has been added or removed from a network, and may perform the operations as discuss herein in response to the indication.

Thus, as described in connection with FIG. 1, and in contrast to prior art systems, the security server 102 can including functionality for active inventory discovery for network security, including enumerating through network devices, determining capabilities of device, and applying security policies the devices included therein. These and other aspects of the active inventory discovery are described herein.

By way of example, and without limitation, an example trusted network may include an HTTP server installed at a first time. A security server may implement one or more security policies to control traffic flowing to and from the HTTP server. However, at a second time after the first time, a user may install a SMTP email server in the same device hosting the HTTP server. Further, the user may not updated any security policies at the security server, and the one or more security policies may not apply to the SMTP email server. However, according to the discloses systems and techniques, the security server may actively discover the devices on the trusted network (including the newly added SMTP email server), may enumerate through the ports on the hosting device, may determine a policy associated with the SMTP email server, and may update the one or more security policies to provide comprehensive network security.

Turning to the devices 122, 124, and 126 of the trusted network devices 104, the trusted network devices 104 can be any sort of device capable of engaging in wired or wireless communication with other, remote devices. Thus, the devices 122, 124, and 126 can include, but are not limited to, servers, smart phones, mobile phones, cell phones, tablet computers, portable computers, laptop computers, personal digital assistants (PDAs), electronic book devices, smart appliances, or any other electronic devices that can generate, request, receive, transmit, or exchange voice, video, and/or digital data in the environment 100. The devices 128, 130, and 132 of the untrusted network devices 106 may include any types of devices as discussed herein, as well.

In some instances, the networks 108 and 110 can comprise a mobile telecommunications network (MTN) configured to implement one or more of the second, third, and fourth generation (2G, 3G, and 4G) cellular-wireless access technologies discussed above. Thus, the MTN can implement GSM, UMTS, and/or LTE/LTE Advanced telecommunications technologies. Further, the security server 102 and the various devices 122, 124, 126, 128, 130, and 132 implementing the GSM, UMTS, LTE, LTE Advanced, and/or HSPA+ telecommunications technologies can include, but are not limited to, a combination of: base transceiver stations BTSs (e.g., NodeBs, Enhanced-NodeBs), Radio Network Controllers (RNCs), serving GPRS support nodes (SGSNs), gateway GPRS support nodes (GGSNs), proxies, a mobile switching center (MSC), a mobility management entity (MME), a serving gateway (SGW), a packet data network (PDN) gateway (PGW), an evolved packet data gateway (e-PDG), or any other data traffic control entity configured to communicate, convert, and/or route data packets between networks, the security server 102, and/or remote devices in other networks. Further, it is understood in the context of this disclosure that the techniques discussed herein can also be implemented in other networking technologies, such as nodes that are part of a wide area network (WAN), metropolitan area network (MAN), local area network (LAN), neighborhood area network (NAN), personal area network (PAN), or the like.

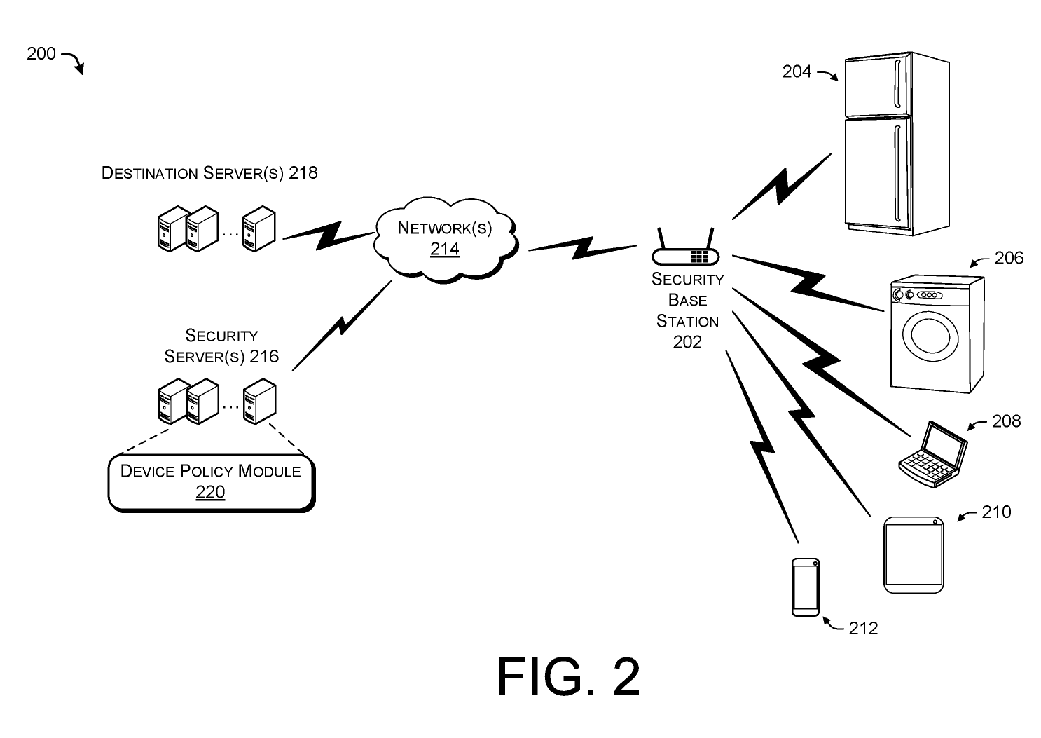

FIG. 2 illustrates an example environment 200 including a security base station for implementing the network security in a home network, for example. The environment may include a security base station 202 communicatively coupled with one or more network devices 204, 206, 208, 210, and 212, and coupled to one or more networks 214. The network 214 may be communicatively coupled to one or more security servers 216 and/or to one or more destination servers 218.

As may be understood in the context of this disclosure, the security servers 216 and the security base station 202 may include similar functionality as described in connection with the security server 102 of FIG. 1. That is, the security servers 216 and the security base station 202 may include a firewall module 112, a network enumeration module 114, a device catalog module 116, a policy module 118, and/or a scheduling module 120. Alternatively, the modules may be distributed in any combination between the security servers 216 and the security base station 202, and/or may operate in serial or parallel as discrete or duplicative processes. Further, the security servers 216 may include a device policy module 220, to be explained below.

The security base station 202 and the network devices 204, 206, 208, 210, and 212 may comprise a trusted home network, with the network devices 204, 206, 208, 210, and 212 comprising trusted network devices. As illustrated, the network device 204 may be a smart appliance such as a smart refrigerator, and may include computing functionality including but not limited to: displaying or facilitating audio, video, and/or textual communications; displaying notification; tracking items in the refrigerator; displaying weather or calendar updates; etc. The network device 206 may be a smart appliance such as a smart washing machine or a smart dryer, and may include computing functionality including but not limited to: displaying or facilitating audio, video, and/or textual communications; communicating notifications (such as a status) to remote devices; etc. The network devices 208, 210, and 212 may be computing devices such as a laptop computer, a tablet computing device, and/or a smartphone, as examples, and may be capable of transmitting and/or receiving any type of digital information and performing any computing tasks.

When a network device (e.g., one or more of the network devices 204, 206, 208, 210, and 212) establishes a connection with the security base station 202, the security base station 202 can provide an IP address to the network device. Considering a case where the network device 204 is connected to the security base station 202, the security base station 202 can provide an IP address to the network device 204, allowing the network device 204 to communicate with one or more devices via the network 214. For example, the smart device 204 may be able to display weather updates on a display associated with the network device 204 and may be able to receive firmware updates from the manufacturer of the network device 204.

At least partially in response to providing an IP address to the network device 204, the security base station 202 may apply a default security policy to the network device 204 to provide network access to the network device 204. Further, at least partly in response to the security base station 202 providing the IP address to the device 204, the security base station 202 may scan the devices connected to the security base station 202 to determine protocols, ports, etc. associated with each device. That is, the security base station 202 may determine a map of the device connected to the security base station. Further, the security base station 202 may enumerate through the devices coupled to the security base station 202 to determine a device profile associated with each device on the network.

In response to determining a device profile associated with one or more of the network devices 204, 206, 208, 210, and 212, the security base station 202 may provide an indication of the device profile to the security servers 216. In turn, the security servers 216, based at least in part on the device profile, can determine a device policy stored in the device policy module 220 that is associated with the network device, such as the network device 204. For instance, the device profile may indicate that the network device 204 is associated with various ports and protocols, and is manufactured by a particular manufacturer. Based at least in in part on this device profile, the security servers 216 may determine that the network device 204 is to be permitted to access a destination server (e.g., one of the destination servers 218) associated with a weather service and a destination server associated with a software update service associated with the device manufacturer of the network device 204. However, the security servers 216 may determine that the network device 204 may not access other devices, or may otherwise restrict or limit access to the networks 214 based on the expected capabilities of the network device 204.

In some instances, a device manufacturer may provide a security policy to the device policy module 220 such that when a user connects the network device 204 to the security base station 202, the security base station 202 contacts the security servers 216 to provide a security policy specific to the network device 204. Thus, the device policy module 220 may store or manage security profiles associated with specific devices, classes of devices, devices associated with specific manufacturers, etc. In some instances, if a security policy cannot be determined for a particular device, the device policy module may determine that the particular device is similar to another device, and if the similarity is within a confidence threshold, may determine to apply a security policy associated with another device to the particular device.

After determining a security policy associated with the network device 204, for example, the security policy can be transmitted to the security base station 202 or otherwise selected and/or implemented on the security base station 202 to provide network access to the network device 204.

In some instances, when the network device 204 is initially connected to the security base station 204, the security base station 204 can discover the network device 204 as described herein and cause a graphical user interface or indication to be presented on a computing device, such as the network device 204 or 212. In turn, a user may confirm or otherwise indicate that the device profile associated with the network device 204 is correct, or indicate that a type of device has been connected to the security base station 202. In some instances, the security base station 202 may present a user interface on any computing device to allow one or more users to accept, confirm, modify, etc. the security policies applied to the network devices 204, 206, 208, 210, and 212.

In some instances, the security base station 202 may determine that a network device, such as the network device 212, should have unrestricted access (or any level of access) to any network destinations. In some instances, with respect to the network device 210, a user may access a user interface presented by the security base station 202 to limit access by the network device 210 to the network 214, for example, for parental controls.

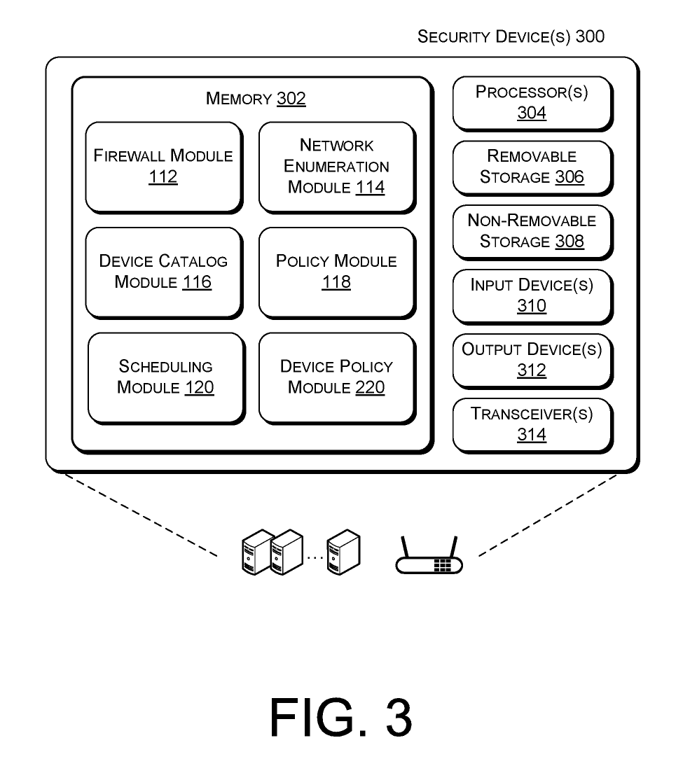

FIG. 3 illustrates an example security device 300 configured to implement the active network discovery for network security, as discussed herein. In some embodiments, the security device 300 can correspond to the security server 102 of FIG. 1 or the security base station 202 of FIG. 2. It is to be understood in the context of this disclosure that the security device 300 can be implemented as a single device or as a plurality of devices with modules and data distributed among them. For example, the firewall module 112, the network enumeration module 114, the device catalog module 116, the policy module 118, the scheduling module 120, and the device policy module 220 can provide functionality to the security device 300 to provide the active network discovery for network security, as described herein.

As illustrated, the security device 300 comprises a memory 302 storing the firewall module 112, the network enumeration module 114, the device catalog module 116, the policy module 118, the scheduling module 120, and the device policy module 220. In some instances, the security device 300 may include any number of modules described herein (e.g., the security device 300 may include a plurality of firewall modules 112). Also, the security device 300 includes processor(s) 304, a removable storage 306 and non-removable storage 308, input device(s) 310, output device(s) 312, and transceiver(s) 314.

In various embodiments, the memory 302 is volatile (such as RAM), non-volatile (such as ROM, flash memory, etc.) or some combination of the two. The firewall module 112, the network enumeration module 114, the device catalog module 116, the policy module 118, the scheduling module 120, and the device policy module 220 stored in the memory 302 can comprise methods, threads, processes, applications or any other sort of executable instructions. The firewall module 112, the network enumeration module 114, the device catalog module 116, the policy module 118, the scheduling module 120, and the device policy module 220 can also include files and databases.

In some embodiments, the processor(s) 304 is a central processing unit (CPU), a graphics processing unit (GPU), or both CPU and GPU, or other processing unit or component known in the art.

The security device 300 also includes additional data storage devices (removable and/or non-removable) such as, for example, magnetic disks, optical disks, or tape. Such additional storage is illustrated in FIG. 3 by removable storage 306 and non-removable storage 308. Tangible computer-readable media can include volatile and nonvolatile, removable and non-removable media implemented in any method or technology for storage of information, such as computer readable instructions, data structures, program modules, or other data. Memory 302, removable storage 306 and non-removable storage 308 are all examples of computer-readable storage media. Computer-readable storage media include, but are not limited to, RAM, ROM, EEPROM, flash memory or other memory technology, CD-ROM, digital versatile discs (DVD), content-addressable memory (CAM), or other optical storage, magnetic cassettes, magnetic tape, magnetic disk storage or other magnetic storage devices, or any other medium which can be used to store the desired information and which can be accessed by the security device 300. Any such tangible computer-readable media can be part of the security device 300.

The security device 300 also can include input device(s) 310, such as a keypad, a cursor control, a touch-sensitive display, voice input device, etc., and output device(s) 312 such as a display, speakers, printers, etc. These devices are well known in the art and need not be discussed at length here.

As illustrated in FIG. 3, the security device 300 also includes one or more wired or wireless transceiver(s) 314. For example, the transceiver(s) 314 can include a network interface card (NIC), a network adapter, a LAN adapter, or a physical, virtual, or logical address to connect to the networks 108, 110, 214, or the various trusted or untrusted network devices. To increase throughput when exchanging wireless data, the transceivers 314 can utilize multiple-input/multiple-output (MIMO) technology. The transceiver(s) 314 can comprise any sort of wireless transceivers capable of engaging in wireless, radio frequency (RF) communication. The transceivers 314 can also include other wireless modems, such as a modem for engaging in Wi-Fi, WiMax, Bluetooth, or infrared communication.

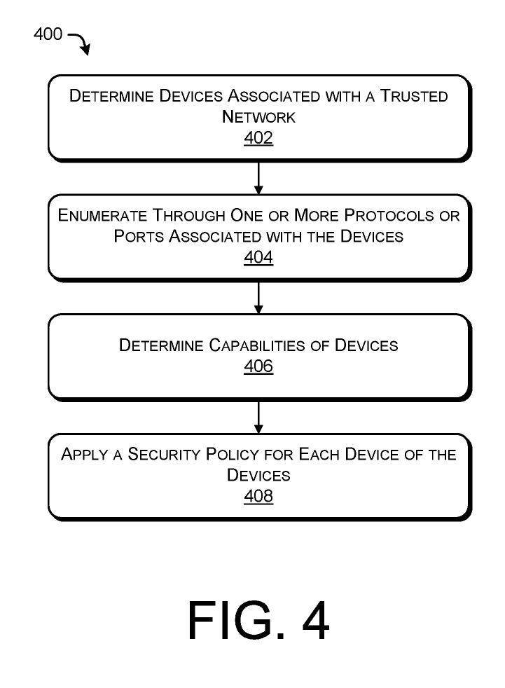

FIGS. 4-6 illustrate example processes in accordance with embodiments of the disclosure. These processes are illustrated as logical flow graphs, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

FIG. 4 illustrates an example process 400 for discovering devices on a network and implementing network security. The example process 400 can be performed by the security server 102, the security base station 202, or the security device 300, for example. Some or all of the process 400 can be performed by one or more devices in the environments 100 or 200, for example.

At operation 402, the process can include determining devices associated with a trusted network. For example, the operation 402 can include accessing an IP table or routing table listing devices connected to a network. In some instances, a security sever 102, for example, can provide IP addresses or network addresses to trusted devices in a network. The list of IP addresses can be accessed or consulted to determine one or more devices associated with the trusted network. In some instances, the operation 402 may include receiving a list or range of IP addresses or network addresses associated with a trusted network. In some instances, the operation 402 may include receiving one or more device addresses to associate with a trusted network. In some instances, the operation 402 may include performing one or more network mapping operations, such as Nmap, to determine devices associated with a trusted network.

At operation 404, the process can include enumerating through one or more protocols or ports associated with the devices associated with the trusted network. For example, the operation 404 can include discovering one or more hosts and/or devices on the trusted network by using discovery protocols or sending messages in according with protocols such as ICMP (Internet Control Message Protocol) and SNMP (Simple Network Management Protocol) to gather information. Upon identifying a host or device, the operation 404 can include identifying one or more functions of the host or device. Further, the operation 404 can include determining a unique identifier associated with the host, device, or operating system. In some instances, the operation 404 can include determining open ports and sending various messages to the ports or applying various scripts to the ports to determine capabilities or vulnerabilities of the ports.

At operation 406, the process can include determining capabilities of the devices. As mentioned above, this operation 406 can include sending various messages to the devices or applying various scripts or programs to the devices to determine capabilities of the devices. In some instances, this operation may include determining active ports and TCP/UDP functionalities associated with each port. For example, following a response from a device (e.g., in response to the IMCP or SNMP messages), the operation can include sending packets or messages to the device in accordance with TCP or UDP to determine capabilities of various ports of the device. In some instances, this operation may include determining what functions a device provides to other devices in the trusted network (e.g., to determine which ports/protocols need to be active to satisfy the requirements of the device).

At operation 408, the process can include applying a security policy for each device of the devices. For example, the security policy can control traffic associated with a device that is incoming to the trusted network or outgoing from the network. The security policies may also control traffic that is internal to the trusted network amongst devices that are internal to the trusted network. As may be understood, any type of security policy can be applied to the devices, and may be applied as updated rules or policies in a firewall implemented in the security devise discussed herein.

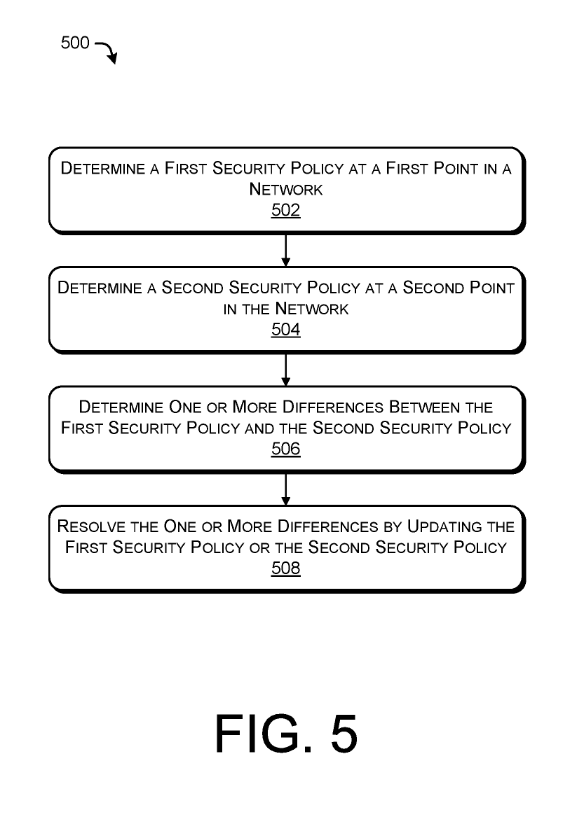

FIG. 5 illustrates an example process 500 for resolving network security policies between devices in a network. The example process 500 can be performed by any combination of security servers 102, security base stations 202, or security devices 300, for example. Some or all of the process 500 can be performed by one or more devices in the environments 100 or 200, for example.

At operation 502, the process can include determining a first security policy at a first point in a network. For example, a geographically distributed network may include a plurality of security servers, such as the security sever 102 in FIG. 1. In some instances, due in part to the geographical distribution of devices in a trusted network, untrusted network devices seeking access to the trusted network devices may communicate with the trusted network through a first security server (e.g., a first point in a network) or from a second security server (e.g., a second point in a network, discussed below). Thus, each security server can determine security policies to control traffic by and between the trusted network devices and the untrusted network devices. In some instances, the operation 502 may include querying a first security server to determine security policies associated with the first security server.

At operation 504, the process can include determining a second security policy at a second point in the network. As discussed above, the second security policy may provide access to a geographically distributed network at a second point, and may implement the second security policy to control traffic by and between the trusted network devices and the untrusted network devices, as discussed herein. In some instances, the operation 504 may include querying a second security server to determine security policies associated with the second security server.

At operation 506, the process can include determining one or more differences between the first security policy and the second security policy. For example, the operation can include determining that the first security policy includes a policy associated with a first trusted network device, and the second security policy includes a policy associated with the first trusted network device. Further, the operation can include determining that the first security policy associated with the first trusted network device has one or more differences in implementation between the second security policy associated with the second security policy. In some instances, the operation 506 may include determining that the first security policy includes a first default security policy and the second security policy includes a second default security policy different than first default security policy. In some instances, the operation 506 may include determining that the first security policy includes a first policy for a class of devices and that the second security policy includes a second policy for the class of devices that is different than the first policy.

At operation 508, the process can include resolving the one or more difference by updating the first security policy or the second security policy. In some instances, the operation 508 may include updating both the first security policy and the second security policy. In some instances, the operation 508 may include triggering the active inventory discovery processes at the first point in the network and at the second point in the network to discover device, enumerate through the network, and apply security policies, as discussed herein. In some instances, the operation 508 may include determining which security policy is more restrictive, and establishing that security policy as the security policy to be common between the first point and the second point. In some instances, the operation can include determining which security policy is least restrictive and establishing that security policy as the common policy. In some instances, a security policy that was determined more recently (e.g., in time) may be established as the common policy. In some instances, a security device may be designated as a master security device and any differences with the master security device may be resolved by applying the security policy from the master security device. As may be understood, any number of techniques may be used to resolve security policy differences, as discussed herein.

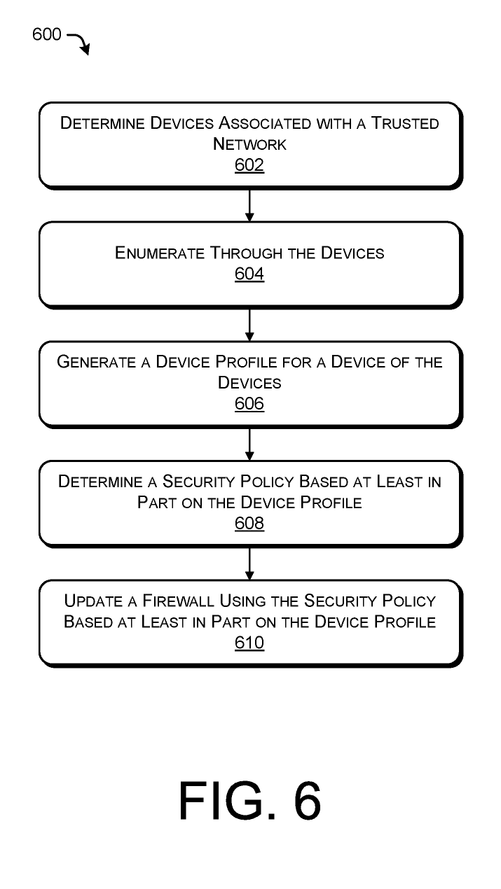

FIG. 6 illustrates an example process 600 for applying a security policy to a device based on a device profile. The example process 600 can be performed by the security server 102, the security base station 202, or the security device 300, for example. Some or all of the process 600 can be performed by one or more devices in the environments 100 or 200, for example.

At operation 602, the process can include determining devices associated with a trusted network. In some instances, this operation 602 can perform similar operation as described above with respect to the operation 402. In some instances, such as in a home network context, this operation can be determined in response to a device being connected to a network, or in response to an IP address being assigned to a device. In some instances, the operation 602 can be performed at regular or irregular intervals, on demand, or on any schedule, in accordance with embodiments of the disclosure.

At operation 604, the process can include enumerating through the devices. In some instances, this operation 604 can perform similar operations as described above with respect to the operation 404. For example, the operation 604 can include determining various protocols and/or ports available or being used by the devices connected to the network.

At operation 606, the process can include generating a device profile for a device of the devices. In some instances, the device profile may include an overview of the capabilities of each device, including which protocols and/or ports are available and/or operational on the device. In some instances, the operation 606 may include receiving an indication from the device of various network addresses that the device intends to contact or communicate with in order to provide services at the device. In some instances, the operation 606 may include receiving a device identifier (such as a Media Access Control (MAC) address, an International Mobile Equipment Identity (IMEI), etc.), and/or an identification of a manufacturer, model number, version identifier, etc., associated with the device.

At operation 608, the process can include determining a security policy based at least in part on the device profile. For example, the operation 608 can include accessing a database including security policies indexed by device profile and may include determining a security policy. In some instances, the security policy can be provided by a manufacturer of the device. In some instances, if a security policy is not provided for a device associated with the security policy, the operation 608 can include making a determination (e.g., associated with a confidence level) that a device profile is associated with a class of devices, and may provide a security policy for the device associated with the class of devices.

At operation 610, the process can include updating a firewall using the security policy based at least in part on the device profile. In some instances, the firewall can be implemented in a security server, a security base station, or a security device, as discussed herein. After the firewall is updated in accordance with the operation 610, the process can include facilitating communications by and between one or more trusted network devices and one or more untrusted network devices, as described herein.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A security server comprising:
one or more processors;
a memory; and
one or more modules stored in the memory and executable by the one or more processors to perform operations comprising:
controlling, via a firewall implemented in the security server, network traffic between a trusted network and an untrusted network;
determining one or more trusted network devices associated with the trusted network;
enumerating through a trusted network device of the one or more trusted network devices to determine one or more protocols and one or more ports in operation on the trusted network device;
determining a security policy to apply to the trusted network device based at least in part on the one or more protocols and the one or more ports in operation on the trusted network device; and
updating the firewall implemented in the security server with the security policy associated with the trusted network device.

2. The security server of claim 1, the operations further comprising maintaining an active inventory of devices associated with the trusted network, the active inventory of devices including at least a catalog of devices and one or more protocols and one or more ports associated with individual ones of the active inventory of devices.

3. The security device of claim 1, the operations further comprising:
receiving a first security policy based at least in part on a designed topology of the trusted network;
configuring the firewall with the first security policy;
determining a second security policy based at least in part on a first updated topology of the trusted network, the first updated topology associated with a first time;
updating the firewall with the second security policy;
determining a third security policy based at least in part on a second updated topology of the trusted network, the second updated topology associated with a second time after the first time; and
updating the firewall with the third security policy.

4. The system of claim 1, wherein the enumerating through the trusted network device includes:
transmitting one or more ICMP (Internet Control Message Protocol) messages or one or more SNMP (Simple Network Management Protocol) messages to the trusted network device; and
receiving, based at least in part on the one or more ICMP messages or the one or more SNMP messages, at least one message from the trusted network device including an indication of the one or more protocols or the one or more ports in operation on the trusted network device.

5. A system comprising:
one or more processors;
a memory; and
one or more modules stored in the memory and executable by the one or more processors to perform operations comprising:
determining one or more trusted network devices associated with a trusted network;
enumerating through a trusted network device of the one or more trusted network devices to determine a configuration of the trusted network device;
determining a security policy to apply to the trusted network device based at least in part on the configuration; and
updating a firewall with the security policy associated with the trusted network device.

6. The system claim 5, wherein the firewall is implemented in a security server, and wherein the operations are performed by the security server.

7. The system of claim 5, wherein determining the configuration of the trusted network device includes determining one or more protocols and one or more ports in operation on the trusted network device.

8. The system of claim 5, wherein the determining the one or more trusted network devices associated with the trusted network includes one or more of:
accessing a routing table associated with the firewall;
accessing an Internet Protocol (IP) table associated with the firewall; or
receiving a range of network addresses associated with the trusted network.

9. The system of claim 5, the operations further comprising:
determining a device profile associated with the trusted network device;
providing an indication of the device profile to a server storing a plurality of security policies; and
selecting the security policy from the plurality of security policies based at least in part on the indication of the device profile.

10. The system of claim 9, the operations further comprising receiving the security policy associated with the trusted network device from a manufacturer of the trusted network device.

11. The system of claim 5, wherein the security policy is a first security policy associated with a first location in a geographically distributed network, the operations further comprising:
determining a second security policy associated with a second location in the geographically distributed network;
determining that the second security policy is associated with the trusted network device;
determining a difference between the first security policy and the second security policy;
resolving the difference between the first security policy and the second security policy; and
updating at least one of the first security policy or the second security policy based at least in part on the resolving the difference between the first security policy and the second security policy.

12. The system of claim 5, the operations further comprising controlling network traffic between the trusted network and the untrusted network based at least in part on the security policy.

13. The system of claim 5, wherein the trusted network device is a first trusted network device and wherein the security policy is a first security policy, the operations further comprising:
determining a second security policy for a second trusted network device of the one or more trusted network devices; and
updating the firewall with the second security policy associated with the second trusted network device, wherein the first security policy is different than then second security policy.

14. The system of claim 5, the operations further comprising:
updating an active inventory of devices associated with the trusted network based at least in part on an update schedule;
determining one or more security policies based at least in part on the active inventory of devices; and
updating the firewall with the one or more security policies based at least in part on the update schedule.

15. A processor-implemented method comprising:
determining one or more trusted network devices associated with a trusted network;
enumerating through a trusted network device of the one or more trusted network devices to determine a configuration of the trusted network device;
determining a security policy to apply to the trusted network device based at least in part on the configuration; and
updating a firewall with the security policy associated with the trusted network device.

16. The processor-implemented method of claim 15, wherein determining the configuration of the trusted network device includes determining one or more protocols and one or more ports in operation on the trusted network device.

17. The processor-implemented method of claim 15, wherein the determining the one or more trusted network devices associated with the trusted network includes one or more of:
accessing a routing table associated with the firewall;
accessing an Internet Protocol (IP) table associated with the firewall; or
receiving a range of network addresses associated with the trusted network.

18. The processor-implemented method of claim 15, further comprising:
determining a device profile associated with the trusted network device;
providing an indication of the device profile to a server storing a plurality of security policies; and
selecting the security policy from the plurality of security policies based at least in part on the indication of the device profile.

19. The processor-implemented method of claim 15, further comprising:
receiving a first security policy based at least in part on a designed topology of the trusted network;
configuring the firewall with the first security policy;
determining a second security policy based at least in part on a first updated topology of the trusted network, the first updated topology associated with a first time;
updating the firewall with the second security policy;
determining a third security policy based at least in part on a second updated topology of the trusted network, the second updated topology associated with a second time after the first time; and
updating the firewall with the third security policy.

20. The processor-implemented method of claim 15, further comprising:
transmitting an ICMP (Internet Control Message Protocol) message to the trusted network device;
receiving, based at least in part on the ICMP message, a response from the trusted network device;
determining that the trusted network device is configured to operate via one or more Transmission Control Protocol (TCP) port or one or more User Datagram Protocol (UDP) port; and
determining the security policy based at least in part on the one or more TCP port or the one or more UDP port.
